(19) United States
(12) Patent Application Publication
(10) Pub. No.: US 2025/0378357 A1
(43) Pub. Date: Dec. 11, 2025

(54) METHODS AND APPARATUS FOR MULTI-MODAL ANOMALY DETECTION

(71) Applicant: Intel Corporation, Santa Clara, CA (US)

(72) Inventor: Anthony Rhodes, Portland, OR (US)

(73) Assignee: Intel Corporation, Santa Clara, CA (US)

(21) Appl. No.: 19/304,014

(22) Filed: Aug. 19, 2025

(51) Int. Cl. G06N 7/01; G06N 3/0464

(52) U.S. Cl. CPC G06N 7/01; G06N 3/0464

(57) ABSTRACT

An example apparatus includes interface circuitry, machine-readable instructions, and at least one processor circuit to be programmed by the machine-readable instructions to generate a probability distribution based on latent embeddings extracted from a dataset, the probability distribution representing interactions between a plurality of data modalities, and determine an anomaly detection score based on the probability distribution, the anomaly detection score corresponding to at least one of (1) an anomaly of a single data modality or (2) an anomaly of two or more data modalities.

### BACKGROUND

Automated anomaly detection techniques seek to identify data anomalies to improve data quality through assessment of data points that deviate from expected patterns (e.g., irrelevant and/or inaccurate outliers). Detection of data anomalies can be performed in combination with machine learning to automatically learn patterns from historical data and pinpoint deviations in real-time. Effective anomaly detection supports manufacturing processes, quality control assessments, and deepfake detection analyses.

### BRIEF DESCRIPTION OF THE DRAWINGS

FIG. 1 illustrates an example Decomposable Probabilistic Multi-Modal Anomaly Detection (DP-MMAD) workflow as performed by anomaly detector circuitry in accordance with methods and apparatus disclosed herein.

FIG. 2 illustrates an example estimation of an importance score associated with the DP-MMAD workflow, as performed by the anomaly detector circuitry of FIG. 1.

FIG. 3 illustrates an example convolutional neural network (CNN)-based, multi-modal fusion model for anomaly detection based on the DP-MMAD workflow of FIG. 1.

FIG. 4 illustrates example experimental results for a Modified National Institute of Standards and Technology (MNIST) dataset using the multi-modal fusion model of FIG. 3.

FIG. 5 illustrates example experimental results for a Fashion Modified National Institute of Standards and Technology (Fashion-MNIST) dataset using the multi-modal fusion model of FIG. 3.

FIG. 6 is a block diagram of an example implementation of the anomaly detector circuitry of FIG. 1 constructed in accordance with teachings of this disclosure to perform decomposable probabilistic multi-modal anomaly detection.

FIG. 7 is a flowchart representative of example machine-readable instructions and/or example operations that may be executed, instantiated, and/or performed by example programmable circuitry to implement the example anomaly detector circuitry of FIG. 1.

FIG. 8 is a flowchart representative of example machine-readable instructions and/or example operations that may be executed, instantiated, and/or performed by the example anomaly detector circuitry of FIG. 1 to generate anomaly detection measures for a multi-modal neural network.

FIG. 9 is a flowchart representative of example machine-readable instructions and/or example operations that may be executed, instantiated, and/or performed by the example anomaly detector circuitry of FIG. 1 to perform fitting of Gaussian Mixture Models (GMMs) for modality-specific latent embeddings of a multi-modal classifier.

FIG. 10 is a block diagram of an example processing platform including programmable circuitry structured to execute, instantiate, and/or perform the example machine readable instructions and/or perform the example operations of FIGS. 7-9 to implement the example anomaly detector circuitry of FIG. 1.

FIG. 11 is a block diagram of an example implementation of the programmable circuitry of FIG. 10.

FIG. 12 is a block diagram of another example implementation of the programmable circuitry of FIG. 10.

FIG. 13 is a block diagram of an example software/firmware/instructions distribution platform (e.g., one or more servers) to distribute software, instructions, and/or firmware (e.g., corresponding to the example machine readable instructions of FIGS. 7-9) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Anomalies refer to data points with (e.g., significant) deviations from an expected or normal behavior of a given dataset, including outliers (e.g., sporadic, non-systematic anomalies that lack conformation to general patterns in data), event changes (e.g., sudden or systematic shifts from previous behavior), and drifts (e.g., slow, unidirectional, long-term variations). Anomaly detection (AD) systems assess and compare data points within a dataset using statistical methods (e.g., by leveraging probability distributions to model normal behavior) and/or machine learning algorithms (e.g., detecting patterns and deviations using supervised or unsupervised learning techniques). Automated AD is a ubiquitous challenge in real-world, data-driven predictive and analytical workflows and can be used to support manufacturing processes, quality control assessments, enhance explainability, and identify information-rich data points in datasets.

Multi-modal AD includes identification of anomalies based on information from multiple modalities (e.g., text, images, audio, etc.). Known AD algorithms are generally brittle (e.g., particularly for out-of-distribution detections) due to reliance on a single, system-level prediction. Existing multi-modal AD solutions focus on aspects such as novelty with respect to modality fusion (e.g., combining information from multiple modalities), a narrow scope of data/modality types, self-supervision/reconstruction mechanisms (e.g., training models on unlabeled data), or explainability (e.g., understanding of underlying reasons for detected anomalies). Application of Explainable AI (XAI) and Human-in-the-Loop (HITL) in AD systems is of growing interest across a variety of areas, including cybersecurity, fraud detection, and predictive maintenance.

Examples disclosed herein introduce decomposable probabilistic multi-modal anomaly detection to enrich the explainability and effectiveness of complex, multi-modal AD systems. In examples disclosed herein, Decomposable Probabilistic Multi-Modal Anomaly Detection (DP-MMAD) generates decomposable anomaly detection scores for multi-modal AI systems by leveraging comprehensive, fine-grained modality interactions in addition to modality importance information. In examples disclosed herein, DP-MMAD improves the robustness of AD while enhancing system explainability and trustworthiness. Additionally, example DP-MMAD disclosed herein is sufficiently generalizable (e.g., domain and model-agnostic) and can be applied with respect to any number and/or type of modalities, as well as in unimodal cases (e.g., where sets of features can be treated as nominal modalities). In examples disclosed herein, DP-MMAD does not require additional model training or fine-tuning and can be applied post hoc to a previously trained model. Unlike known AD algorithms, example DP-MMAD disclosed herein yields a system-level AD score in addition to modality-specific AD scores for all modalities present in the system. Furthermore, example DP-MMAD disclosed herein is grounded in a novel probabilistic framework encompassing a combinatorially complete set of modality interactions. In examples disclosed herein, probability models are leveraged to build out nuanced AD measures that are sensitive to both modality interactions and modality importance to enhance both AD robustness and system explainability.

In examples disclosed herein, DP-MMAD renders AD measures for multi-modal neural network systems based on (1) a fitting of Gaussian Mixture Models (GMMs) for modality-specific latent embeddings of a late-fusion-based multi-modal classifier and (2) a fitting of an additional set of joint GMMs over all modality combinations (e.g., using latent model embeddings). Examples disclosed herein identify an importance score for a modality or modalities of interest by pooling and normalizing input feature gradients, since anomaly detection in multi-modal systems is affected by the contribution of a given modality. Additionally, in some examples a decomposable, modality-specific and system-level AD score is defined for a test datum as a linear combination of Mahalanobis distances (e.g., statistical measure that quantifies a distance between a point and a distribution) with respect to the identified modality-specific density functions (e.g., determined using the GMM-based fittings). As such, some examples disclosed herein introduce consistent and accurate automated AD that can be implemented for improving cost and efficiency across manufacturing processes and capabilities, as well as across a diverse array of other application domains, including deepfake detection. Examples disclosed herein can be used to achieve robust and adaptable AD and uncertainty analysis to promote AI-assisted, human executive decision making for deepfake applications.

Examples disclosed herein can be applied in continual learning, HITL, and XAI-based improvements of AD systems. DP-MAAD models comprehensive probabilistic interactions across all modality combinations and differs from contemporary AD techniques by rendering fine-grain structural AD analyses (e.g., per-modality probabilistic AD models), in addition to coarse-grain (e.g., system-level probabilistic AD models) and intermediate modality interactions that can be leveraged to enrich the explainability and effectiveness of complex, multi-modal AD systems.

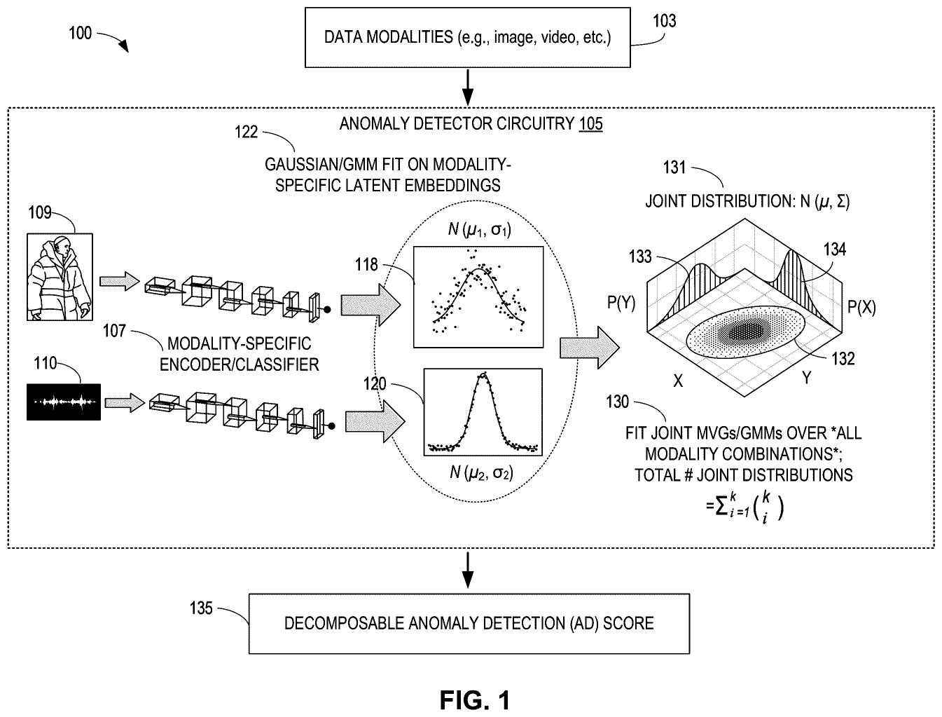

FIG. 1 illustrates an example Decomposable Probabilistic Multi-Modal Anomaly Detection (DP-MMAD) workflow 100 as performed by anomaly detector circuitry 105 in accordance with teachings disclosed herein. In the example of FIG. 1, two or more different data modalities 103 (e.g., image, video, etc.) serve as inputs into the anomaly detector circuitry 105, which processes the data to generate a decomposable anomaly detection (AD) score 135. For example, given data modalities S={x₁, . . . , xₖ} (e.g., where x₁ is a first modality, x₂ is a second modality, etc.) and a multi-modal classifier (f_{Θ}) (e.g., modality-specific encoder/classifier 107) trained on dataset D with respect to the modalities S (103), the anomaly detector circuitry 105 generates AD scores with respect to a test datum x* for the multi-modal system f_{Θ}. In examples disclosed herein, the anomaly detector circuitry 105 passes the data in D (e.g., or data in a hold-out dataset) through the modality-specific encoder/classifier 107. For example, a first type of data modality (e.g., image and/or video data 109) and a second type of data modality (e.g., audio data 110) are processed through the modality-specific encoder/classifier 107. However, any other type of modality and/or quantity of modalities can be used as input into the modality-specific encoder/classifier 107. In examples disclosed herein, the modality-specific encoder/classifier 107 can be a late-fusion-based multi-modal classifier (e.g., combining results of individual modality models after separate processing) or an early-fusion-based multi-modal classifier (e.g., combining modalities at the feature level prior to classification). In examples disclosed herein, the anomaly detector circuitry 105 extracts latent embeddings (e.g., penultimate layer activations) that yield a set of embeddings represented in accordance with Equation 1:

$${D}_{e m b} = \{ {f}_{Θ} ( {x}^{′} ) \vert {x}^{′} ϵ D \} ) \qquad Equation 1$$

In examples disclosed herein, the anomaly detector circuitry 105 identifies the partitioning of this set of latent embeddings (D_{emb}) by modalities S (103) in accordance with Equation 2:

$${D}_{e m b} \vert S = {⋃}_{i = 1}^{k} \{ {f}_{Θ} ( {x}^{′} ) \vert {x}^{′} [ {x}_{i} ] , {x}^{′} ϵ D , {x}_{i} ϵ S \} \qquad Equation 2$$

In the example of Equation 2, f_{Θ}(x′)|x′[xᵢ] represents the latent embedding of datum x′ restricted to a modality xᵢ.

In examples disclosed herein, the anomaly detector circuitry 105 applies an Expectation-Maximization (EM) algorithm to solve the dual optimization problem of fitting a Gaussian Mixture Model (GMM) to each set of latent embeddings {f_{Θ}(x′)|x′[xᵢ], x′ϵD} in D_{emb}|S, such that a GMM is trained to yield a set of GMMs for each modality

$${x}_{i} ϵ S : {\{ {N}_{i}^{1} ( {π}_{i}^{1} , {μ}_{i}^{1} , {\sum }_{i}^{1} ) \}}_{i = 1}^{k} ,$$

where the superscript (¹) denotes a single modality and the index (i) represents a modality index. In the example of FIG. 1, a GMM fit on modality-specific latent embeddings 122 is represented as a first probability distribution 118 based on a first Normal Distribution N (μ₁, σ₁) (e.g., generated for the image and/or video data 109) and a second probability distribution 120 based on a second Normal Distribution N (μ₂, σ₂) (e.g., generated for the audio data 110), where μ₁, μ₂ represent an average of the distribution and σ₁, σ₂ represent a spread or width of the distribution. As such, an algorithm flow generated by the anomaly detector circuitry 105 can be represented as follows:

$$S = \{ {x}_{1 ,} ... , {x}_{k} \} , D , {f}_{Θ} {\to }_{latent emb} EM [ {⋃}_{i = 1}^{k} \{ {f}_{Θ} ( {x}^{′} ) \vert {x}^{′} [ {x}_{i} ] , {x}^{′} ϵ D , {x}_{i} ϵ S \} ] {\to }_{GMM} {\{ {N}_{i}^{1} ( {π}_{i}^{1} , {μ}_{i}^{1} , {\sum }_{i}^{1} ) \}}_{i = 1}^{k} .$$

Subsequently, the anomaly detector circuitry 105 proceeds to fit a set of GMMs across all combinations of modalities (e.g., to capture nuanced modality interactions that enhance the downstream AD signal). In the example of FIG. 1, the anomaly detector circuitry 105 identifies joint Multi-Variate Gaussians (MVGs) or GMMs over all modality combinations (e.g., MVG/GMM fitting 130) and renders probabilistic models over all combinations of modalities in S, such that the total number of such models is represented as

$${\sum }_{i = 1}^{k} ( \begin{matrix}k \\ i\end{matrix} ) .$$

In examples disclosed herein, the set of all combinations of two or more modalities from the set S={x₁, . . . , xₖ} can be denoted as S_{comb}. In particular, the anomaly detector circuitry 105 identifies a set of two-modality combinations that includes a subset of S_{comb} that can be represented as {x₁, x₂}, {x₁, x₃} . . . {x₂, x₃} . . . {xₖ₋₁, xₖ}⊂S_{comb}. Similarly, the set of three-modality combinations is also represented as a subset of S_{comb}, up to k-modality combinations. In examples disclosed herein, the anomaly detector circuitry 105 performs GMM-based fitting {f_{Θ}(x′)|x′[xᵢ], x′ϵD, xᵢϵS_{comb}} in D_{emb}|S, such that a GMM is fitted to each combination of two or more modalities to yield a set of joint distributions (e.g., joint distribution 131 illustrating many sample observations 132 with marginal densities 133, 134) represented as

$${x}_{i} ϵ {S}_{comb} : {\{ {N}_{i}^{j} ( {π}_{i}^{j} , {μ}_{i}^{j} , {\sum }_{i}^{j} ) \}}_{j = 1}^{k} ,$$

where the superscript (^{j}) denotes the number of modalities included in the joint distribution and the index (i) represents the set of relevant modality indices. For example,

$${N}_{234}^{3} ( {π}_{234}^{3} , {μ}_{234}^{3} , {\sum }_{234}^{3} )$$

symbolizes a GMM-based combination of three modalities with an index set of {2,3,4}. The resulting algorithm flow generated by the anomaly detector circuitry 105 can be represented as follows:

$$EM [ {⋃}_{j = 1}^{k} \{ {f}_{Θ} ( {x}^{′} ) \vert {x}^{′} [ {x}_{i} ] , {x}^{′} ϵ D , {x}_{i} ϵ {S}_{comb} \} ] {\to }_{GMM} {\{ {N}_{i}^{j} ( {π}_{i}^{j} , {μ}_{i}^{j} , {\sum }_{i}^{j} ) \}}_{j = 1}^{k} .$$

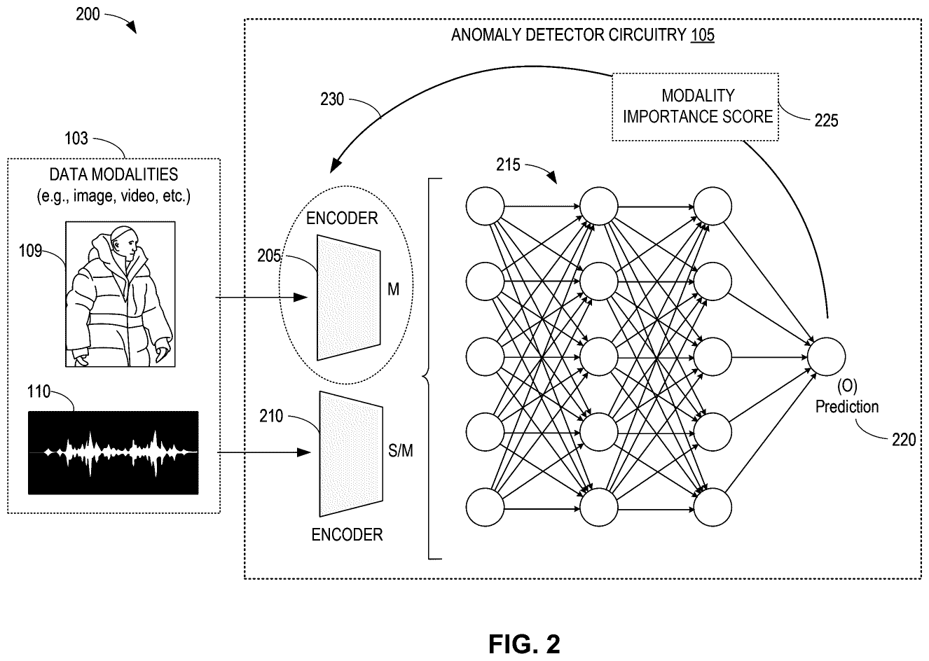

The anomaly detector circuitry 105 also estimates an importance score (λ[M]) for each modality set MϵS∪S_{comb} over all modality combinations by pooling and normalizing input feature gradients, as described in more detail in connection with FIG. 2. For example, the anomaly detector circuitry 105 calculates

$$\vert \frac{\partial {o}_{j}}{\partial {x}_{i}} \cdot {x}_{i} \vert ,$$

an absolute magnitude of the partial derivative of each output neuron (oⱼ) with respect to each input feature (xᵢ) in M, scaled by the magnitude of the input feature (xᵢ). Subsequently, averaging the score(s) over all neurons in a relevant modality set (e.g., M) and normalizing the score(s) with respect to all sets of modalities under consideration (e.g., M and S/M) can be performed to formulate λ[M] in accordance with Equation 3:

$$λ [ M ] = \frac{\frac{1}{\vert M \vert \cdot \vert o \vert} {\sum }_{i ϵ M , j} \vert \frac{\partial {o}_{j}}{\partial {x}_{i}} \cdot {x}_{i} \vert}{\begin{matrix}\frac{1}{\vert S / M \vert \cdot \vert o \vert} {\sum }_{i ϵ S / M , j} \vert \frac{\partial {o}_{j}}{\partial {x}_{i}} \cdot {x}_{i} \vert + \\ \frac{1}{\vert M \vert \cdot \vert o \vert} {\sum }_{i ϵ M , j} \vert \frac{\partial {o}_{j}}{\partial {x}_{i}} \cdot {x}_{i} \vert\end{matrix}} \qquad Equation 3$$

The anomaly detector circuitry 105 further calculates a set of decomposable, modality-specific AD scores in addition to an overall, system-level AD score 135. For example, given a test datum x, modality-specific AD scores can be defined with respect to a modality set MϵS∪S_{comb} in accordance with Equation 4:

$${AD ( x )}_{M} = {\sum }_{[ M ] ϵ S ⋃ {S}_{comb}} λ [ [ M ] ] \cdot MD ( {f}_{Θ} ( x ) \vert x [ [ M ] ] , {π}_{[ M ]} , {μ}_{[ M ]} , {\sum }_{[ M ]} ) \qquad Equation 4$$

In the example of Equation 4, λ[M] represents the importance score of the modality set M, as defined in connection with Equation 3, the notation [M]ϵS∪S_{comb} indicates that the sum in Equation 4 is applied over all joint distributions containing the modality set M, and {μ_{[M]}, Σ_{[M]}} represents the set of GMM parameters for the corresponding joint distribution indexed by [M]. Additionally,

$$MD ( x , {\{ {N}^{j} ( {π}^{j} , {μ}^{j} , {\sum }^{j} ) \}}_{j = 1}^{k} )$$

denotes a GMM-based Mahalanobis distance (MD) with respect to the GMM

$${\{ {N}^{j} ( {π}^{j} , {μ}^{j} , {\sum }^{j} ) \}}_{j = 1}^{k} ,$$

where the Mahalanobis distance can be further defined in accordance with Equation 5:

$$MD ( x , {\{ {N}^{j} ( {π}^{j} , {μ}^{j} , {\sum }^{j} ) \}}_{j = 1}^{k} ) = {\sum }_{j} {π}^{j} \sqrt{{( x - {μ}^{j} )}^{T} {{\sum }^{j}}^{- 1} ( x - {μ}^{j} )} \qquad Equation 5$$

As such, the modality-specific AD score with respect to modality set M for datum x is defined as a linear combination of Mahalanobis distances between the input datum and each joint probability distribution encompassing the modality set M (e.g., as specified by a GMM), where the linear weight is defined as the importance score for the specified modality set. In the example of FIG. 1, the anomaly detector circuitry 105 also identifies the system-level AD score 135 by constructing an analogous sum over the set of all joint probability distributions in accordance with Equation 6:

$$AD ( x ) = {\sum }_{M ϵ S ⋃ {S}_{comb}} λ [ M ] \cdot MD ( {f}_{Θ} ( x ) \vert x [ M ] , {μ}_{M} , {\sum }_{M} ) \qquad Equation 6$$

FIG. 2 illustrates an example estimation of an importance score associated with the DP-MMAD workflow 100 of FIG. 1, as performed by the anomaly detector circuitry 105 of FIG. 1 to identify the relevance of one modality type over another modality type provided as input (e.g., scoring an importance of a first modality relative to a second modality). In the example of FIG. 2, the data modalities 103 (e.g., including the image and/or video data 109 and the audio data 110) can be processed using a late-fusion-based multi-modal classifier, such that encoding (e.g., using a first encoder 205 for the image and/or video data 109 (M) and a second encoder 210 for the audio data 110 (S/M)) is applied to individual modalities and the encoded features processed by a neural network model 215 (e.g., convolutional neural network (CNN)) for feature extraction. However, any other type of multi-modal classifier can be used (e.g., to perform encoding of individual modalities prior to fusion). In some examples, a single data modality (e.g., image and/or video data 109, audio data 110, etc.) can be partitioned into sub-modalities (e.g., mouth and eye-specific sub-modalities for deepfake detection applications, where each sub-modality includes a dedicated classifier). In the example of FIG. 2, the anomaly detector circuitry 105 identifies an output prediction 220 and determines gradient(s) with respect to the output prediction 220 by projecting back to the different input data modalities 103 (e.g., importance score calculation 230) and normalizing resulting modality importance score(s) 225.

As described in connection with FIG. 1, the anomaly detector circuitry 105 estimates the modality importance score 225 (e.g., λ[M] of Equation 3) for each modality set MϵS∪S_{comb} over all modality combinations by pooling and normalizing input feature gradients. For example, the anomaly detector circuitry 105 averages the score(s) over all neurons in a relevant modality set (e.g., M) and normalizes the score(s) with respect to all sets of modalities under consideration (e.g., M and S/M). The importance score 225 represents the relevance of one input modality (e.g., video) over another input modality (e.g., audio) for a particular application (e.g., deepfake assessment), such that a video-based modality can be identified to have a score of 0.8 as compared to a score of 0.2 for an audio-based modality. In examples disclosed herein, the anomaly detector circuitry 105 pulls gradient values over all input feature(s) and normalizes the input feature gradients to account for modalities with varying feature numbers (e.g., 1000 features in an image versus 100 features in an audio signal).

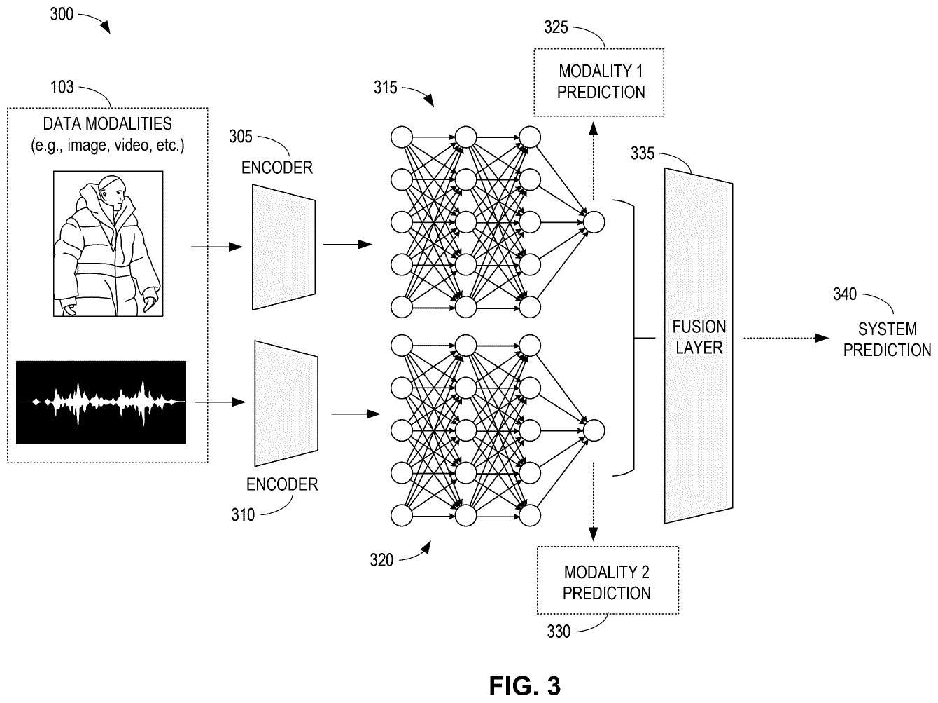

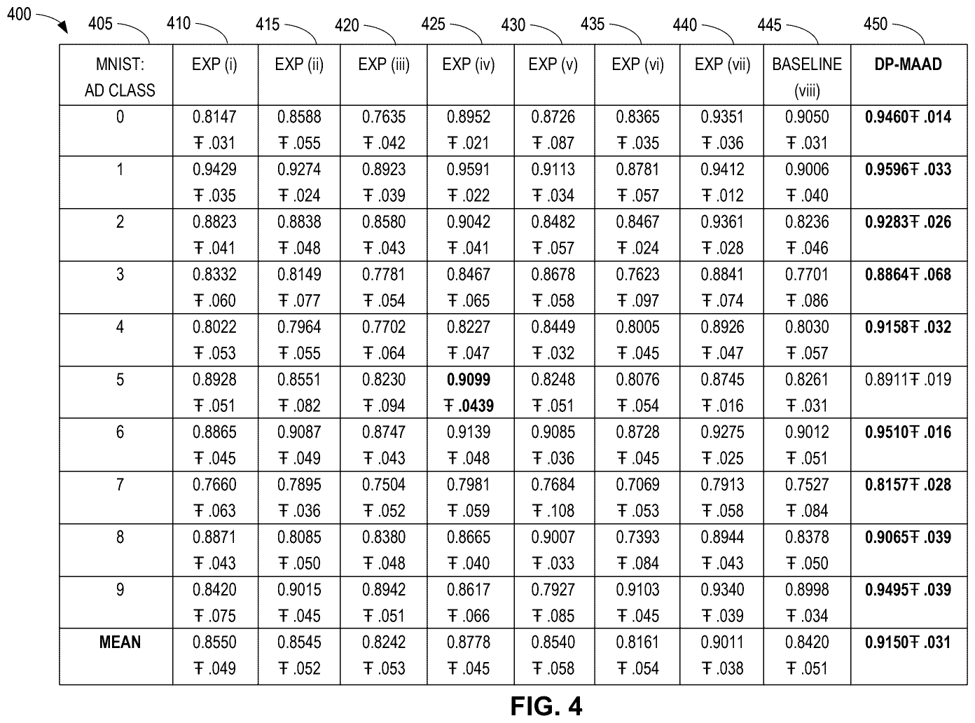

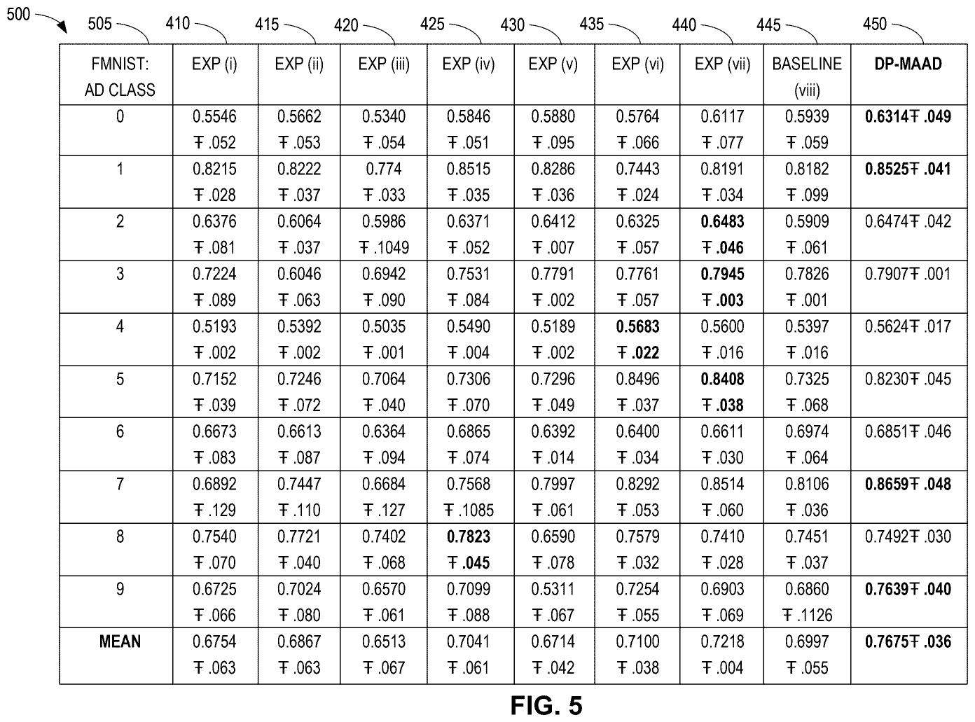

FIG. 3 illustrates an example convolutional neural network (CNN)-based, multi-modal fusion model 300 for anomaly detection based on the DP-MMAD workflow 100 of FIG. 1. In examples disclosed herein, the multi-modal fusion model 300 can be used in conjunction with the anomaly detector circuitry 105 to perform individual experiments (e.g., described in connection with FIGS. 4 and 5) demonstrating the effectiveness of the proposed DP-MMAD workflow 100 for robust, decomposable, and modality-specific anomaly detection. For example, the multi-modal fusion model 300 can be used to enforce independent, modality-specific prediction streams in addition to a multi-modal, system-level prediction. The fusion architecture of the multi-modal fusion model 300 includes parallel and independent model streams that process each modality separately, yielding modality-specific predictions. The parallel streams provide reliable, modality-specific AD scores. For example, the data modalities 103 (e.g., image and/or video data 109 and audio data 110) are processed individually using encoder(s) 305, 310 and neural network(s) 315, 320, respectively, to yield a first prediction 325 for the first modality and a second prediction 320 for the second modality (e.g., including modality specific AD scores). Separately, the multi-modal fusion model 300 fuses the input features (e.g., via a fusion layer 335) to obtain a system-based anomaly detection prediction 340. In examples disclosed herein, the anomaly detector circuitry 105 trains the multi-modal fusion model 300 using a cross-entropy based, multi-objective loss function, where each modality prediction in addition to the overall system prediction contributes to the overall training loss.

FIG. 4 illustrates example experimental results 400 for a Modified National Institute of Standards and Technology (MNIST) dataset using the multi-modal fusion model 300 of FIG. 3. Similarly, FIG. 5 illustrates example experimental results 500 for a Fashion MNIST dataset using the multi-modal fusion model of FIG. 3. The experimental results 400, 500 include Leave-One-Out (LOO) anomaly detection conditions (e.g., training a model on all but one data point and testing on that data point) across nine experimental scenarios, each experiment averaged over five Gaussian Mixture Model (GMM) trials, with reported receiver operating characteristic (ROC) area under the curve (ROC-AUC) mean and standard deviation scores. While the datasets are not inherently multi-modal in nature, the image data associated with the datasets can be divided into left and right images (e.g., splitting each image along a central axis) to obtain bimodal datasets. In examples disclosed herein, the fusion model 300 is trained using ten variants of the fusion model (e.g., ten LOO models per dataset), where for each experimental trial one data class is left out (e.g., identified as an experimental anomalous class). Subsequently, for each of the ten fusion models, corresponding GMM models are trained on the modality-specific and system-level model latent embeddings of the training data (e.g., using the penultimate layer in each case) across all combinations of modalities, as discussed in more detail in connection with FIG. 1. For each of the ten LOO models per dataset, five different sets of GMM model trials are trained to account for variability in GMM models due to stochasticity in the Expectation-Maximization (EM) algorithm initialization and parameter specifications. Each of the 100 model combinations are then tested for each dataset, anomaly class designation, and GMM model, on the full test data (e.g., including all ten nominal dataset classes), averaging results over anomaly classes. In each case, an Adam optimizer is trained for 100 epochs.

In the example of FIGS. 4 and 5, results for anomaly detection (AD) scores as defined in Equation 4 are reported using modality importance values as defined in Equation 3 of DP-MAAD workflow 100. Following normative experimental reporting for AD, ROC-AUC scores (e.g., defined over the interval [0,1]) are reported over the test data in each experimental trial, where the AD scores are used to predict anomaly ground-truth (e.g., non-anomalous data having a target class of ‘0’ and anomalous classes having a target class of ‘1’). Furthermore, FIGS. 4 and 5 show a comparison of the performance of the DP-MAAD score with several ablation and baseline AD scoring mechanisms for a given AD class (e.g., MNIST AD class 405 of FIG. 4 or Fashion-MNIST AD class 505 of FIG. 5), including (1) first experiment 410 with left modality+fused system-level AD score (e.g., unnormalized by modality importance), (2) second experiment 415 with right modality+fused system-level AD score (e.g., unnormalized by modality importance), (3) third experiment 420 with fused system-level AD score (e.g., unnormalized by modality importance), (4) fourth experiment 425 with right modality+left modality+fused system-level AD score (e.g., unnormalized by modality importance), (5) fifth experiment 430 with left modality+fused system-level AD score (e.g., normalized by modality importance), (6) sixth experiment 435 with right modality+fused system-level AD score (e.g., normalized by modality importance), (7) seventh experiment 440 with right modality+left modality+fused system-level AD score (e.g., normalized by modality importance), (8) a baseline 445 with GMM-based MHD for system-level output, and (9) DP-MAAD workflow 450 with right modality+left modality+fused system-level+(left, right, fused) joint distribution AD score (e.g., normalized by modality importance, representing the DP-MAAD score). Considering experimental results 400 and 500, the DP-MAAD workflow 100 disclosed herein strongly outperforms each ablation variant and baseline with respect to both ROC-AUC mean and standard deviation, indicating generalizable AD performance and robustness.

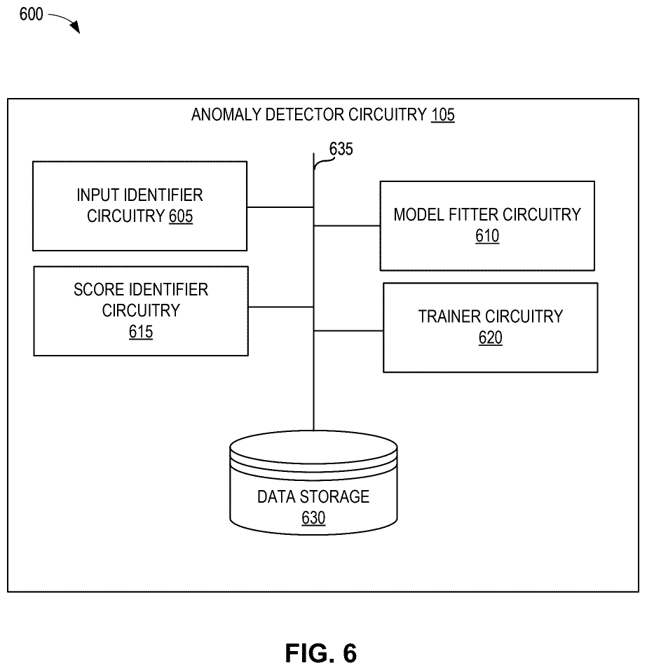

FIG. 6 is a block diagram 600 of an example implementation of anomaly detector circuitry 105 of FIG. 1 constructed in accordance with teachings of this disclosure to perform decomposable probabilistic multi-modal anomaly detection. The anomaly detector circuitry 105 of FIG. 1 may be instantiated (e.g., creating an instance of, bring into being for any length of time, materialize, implement, etc.) by programmable circuitry. For example, programmable circuitry may be implemented by a Central Processing Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the anomaly detector circuitry 105 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 6 may, thus, be instantiated at the same or different times. Some or all of the circuitry of FIG. 6 may be instantiated, for example, in one or more threads executing concurrently on hardware and/or in series on hardware. Moreover, in some examples, some or all of the circuitry of FIG. 6 may be implemented by microprocessor circuitry executing instructions and/or FPGA circuitry performing operations to implement one or more virtual machines and/or containers.

In the example of FIG. 6, the anomaly detector circuitry 105 includes example input identifier circuitry 605, example model fitter circuitry 610, example score identifier circuitry 615, example trainer circuitry 620, and data storage 630 are in communication via an example bus 635.

The input identifier circuitry 605 identifies one or more data modalities (e.g., data modalities 103 of FIG. 1, such as audio, video, image, text, etc.) for processing by a multi-modal model classifier (e.g., late-fusion-based multi-modal classifier, early-fusion-based multi-modal classifier, etc.). In some examples, the input identifier circuitry 605 identifies sub-modalities (e.g., eyes, mouth, etc.) of a modality (e.g., image) for processing based on a given anomaly detection application (e.g., deepfake detection). In examples disclosed herein, the input identifier circuitry 605 identifies a multi-modal classifier (e.g., modality-specific encoder/classifier 107 of FIG. 1) trained on a dataset with respect to the modalities (e.g., a model trained to process and integrate information from various data formats within a given dataset). In some examples, the modality-specific encoder/classifier 107 includes a specific neural network architecture (e.g., convolutional neural network, etc.) to process a given modality and a fusion mechanism for combining the processed data from different modalities (e.g., early fusion to merge data at an early stage or late fusion to process each modality separately before combining outputs at a later stage). In examples disclosed herein, the input identifier circuitry 605 extracts latent embeddings (e.g., penultimate layer activations) in accordance with Equation 1, as described in connection with FIG. 1. Additionally, the input identifier circuitry 605 partitions the set of latent embeddings in accordance with Equation 2, as described in connection with FIG. 1. For example, latent embeddings represent compressed representations of input data that are derived from the penultimate layer (e.g., a layer before the output layer of the neural network). As such, latent embeddings can be used to capture relevant information in a lower-dimensional space, allowing for efficient processing and/or analysis in further downstream tasks.

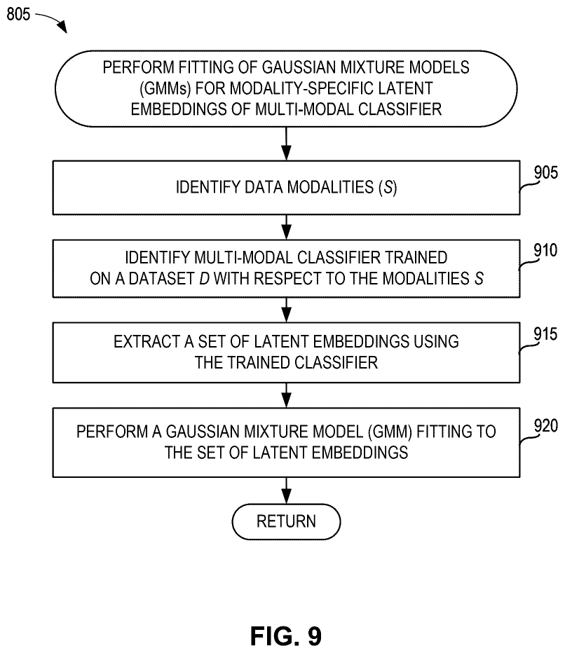

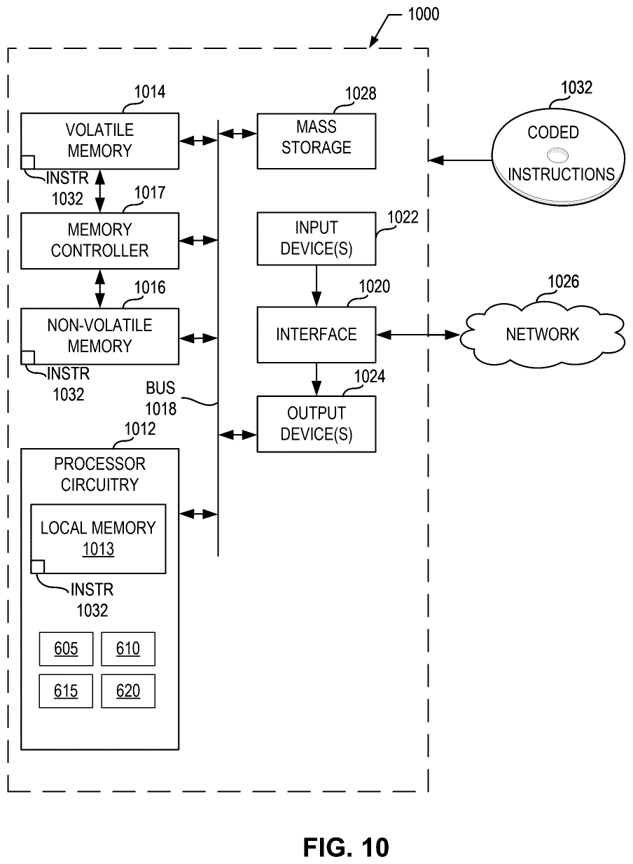

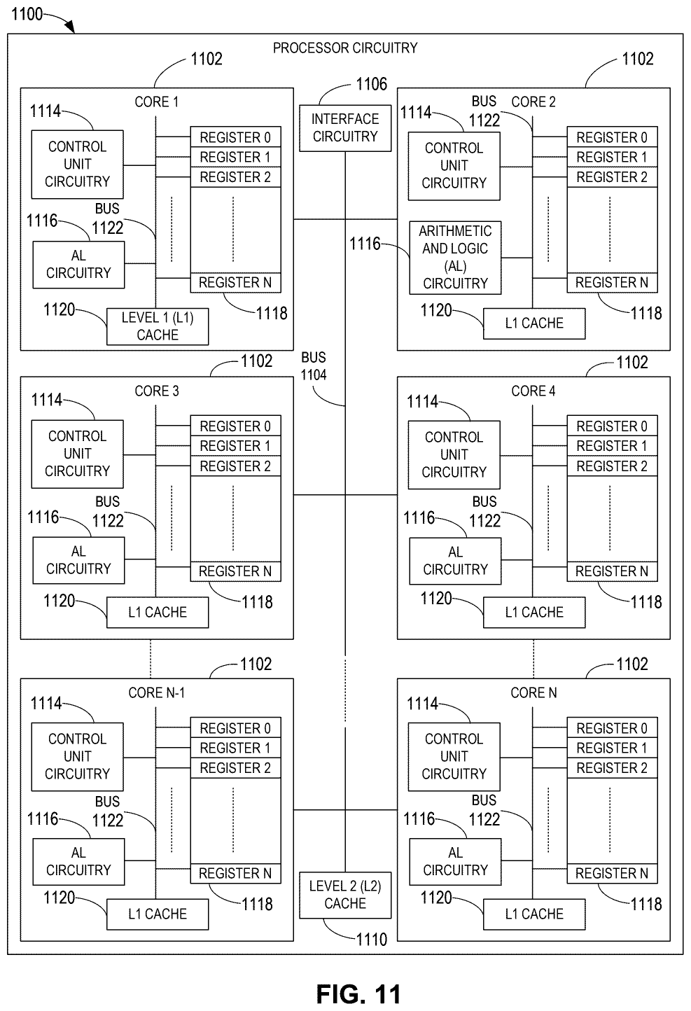

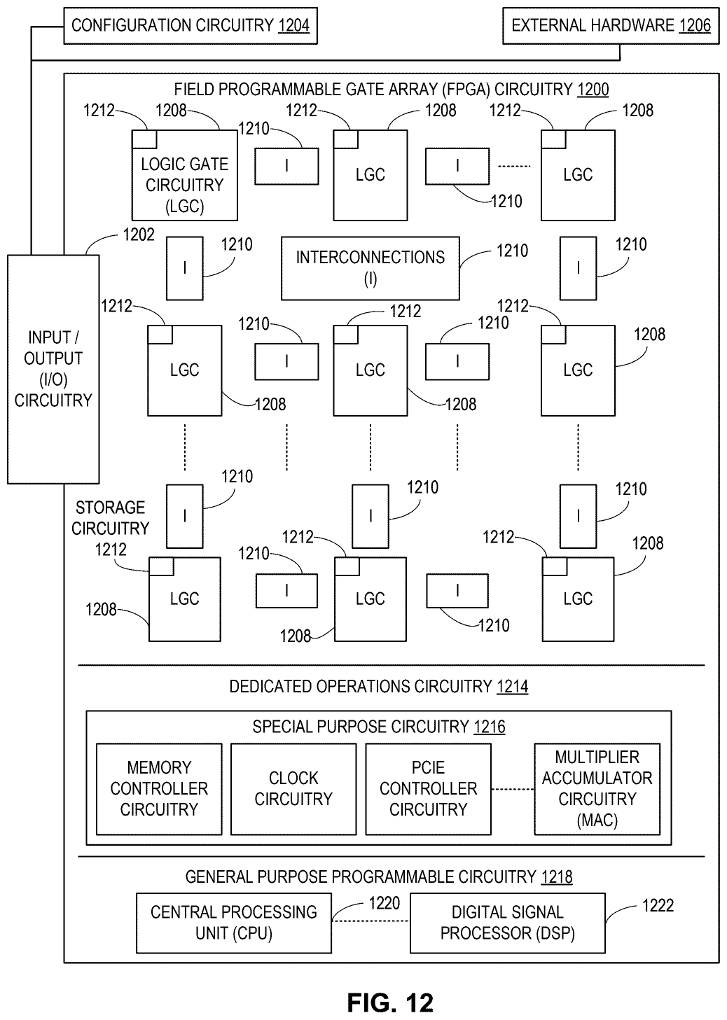

In some examples, the apparatus includes means for identifying an input. For example, the means for identifying an input may be implemented by input identifier circuitry 605. In some examples, the input identifier circuitry 605 may be instantiated by programmable circuitry such as the example programmable circuitry 1012 of FIG. 10. For instance, the input identifier circuitry 605 may be instantiated by the example microprocessor 1100 of FIG. 11 executing machine executable instructions such as those implemented by at least block(s) 905, 910, 915 of FIG. 9. In some examples, the input identifier circuitry 605 may be instantiated by hardware logic circuitry, which may be implemented by an ASIC, XPU, or the FPGA circuitry 1200 of FIG. 12 structured to perform operations corresponding to the machine readable instructions. Additionally or alternatively, the input identifier circuitry 605 may be instantiated by any other combination of hardware, software, and/or firmware. For example, the input identifier circuitry 605 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The model fitter circuitry 610 performs (1) fitting of Gaussian Mixture Models (GMMs) for modality-specific latent embeddings (e.g., GMM fit on modality-specific latent embeddings 122 of FIG. 1) and (2) fitting of a set of GMMs across all combinations of modalities to yield joint distributions (e.g., joint distribution 131 of FIG. 1 generated based on latent embeddings identified using the input identifier circuitry 605). In examples disclosed herein, the model fitter circuitry 610 applies an Expectation-Maximization (EM) algorithm (e.g., used to identify maximum likelihood estimates of parameters in probabilistic models when data is hidden or missing) to perform the GMM fitting to each set of latent embeddings associated with a given modality (e.g., first probability distribution 118 and second probability distribution 120 of FIG. 1). As described in connection with FIG. 1, the model fitter circuitry 610 also identifies joint Multi-Variate Gaussians (MVGs) or GMMs over all modality combinations to obtain joint distributions (e.g., joint distribution 131 of FIG. 1). For example, a GMM represents a weighted sum of multiple MVG distributions, such that each component in a GMM is an MVG. As described in more detail in connection with FIG. 1, the model fitter circuitry 610 identifies the fitting of GMMs for modality-specific latent embeddings using the EM algorithm

$$( e . g . , EM [ {⋃}_{i = 1}^{k} \{ {f}_{Θ} ( {x}^{′} ) \vert {x}^{′} [ {x}_{i} ] , {x}^{′} ϵ D , {x}_{i} ϵ S \} ] {\to }_{GMM} {\{ {N}_{i}^{1} ( {π}_{i}^{1} , {μ}_{i}^{1} , {\sum }_{i}^{1} ) \}}_{i = 1}^{k} )$$

and identifies the join distributions based on the set of all combinations (S_{comb}) of two or more modalities (e.g.,

$$EM [ {⋃}_{j = 1}^{k} \{ {f}_{Θ} ( {x}^{′} ) \vert {x}^{′} [ {x}_{i} ] , {x}^{′} ϵ D , {x}_{i} ϵ {S}_{comb} \} ] {\to }_{GMM} {\{ {N}_{i}^{j} ( {π}_{i}^{j} , {μ}_{i}^{j} , {\sum }_{i}^{j} ) \}}_{j = 1}^{k} ) .$$

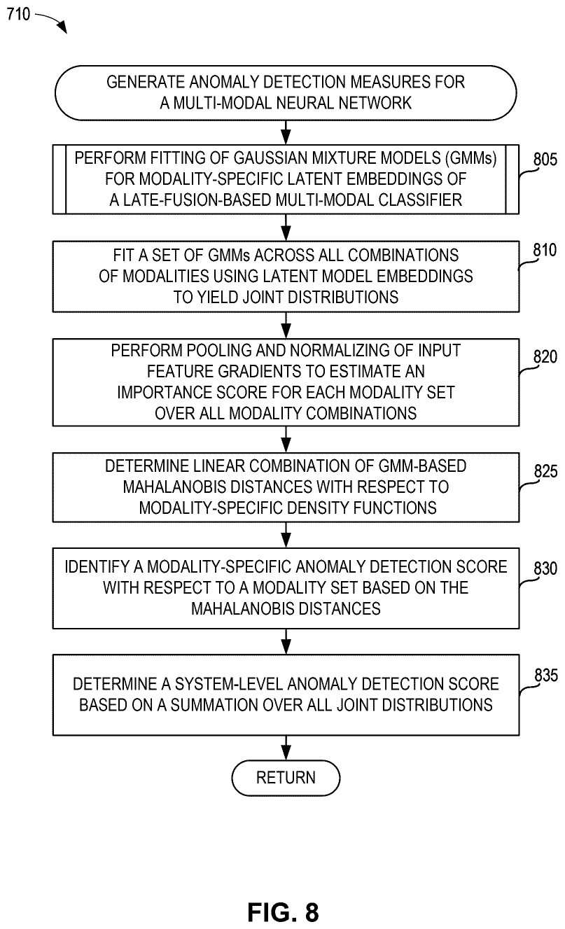

In some examples, the apparatus includes means for generating a probability distribution. For example, the means for generating a probability distribution may be implemented by model fitter circuitry 610. In some examples, the model fitter circuitry 610 may be instantiated by programmable circuitry such as the example programmable circuitry 1012 of FIG. 10. For instance, the model fitter circuitry 610 may be instantiated by the example microprocessor 1100 of FIG. 11 executing machine executable instructions such as those implemented by at least block(s) 805, 810 of FIG. 8. In some examples, the model fitter circuitry 610 may be instantiated by hardware logic circuitry, which may be implemented by an ASIC, XPU, or the FPGA circuitry 1200 of FIG. 12 structured to perform operations corresponding to the machine readable instructions. Additionally or alternatively, the model fitter circuitry 610 may be instantiated by any other combination of hardware, software, and/or firmware. For example, the model fitter circuitry 610 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The score identifier circuitry 615 performs pooling and normalizing of input feature gradients to estimate an importance score for each modality set over all modality combinations (e.g., modality importance score 225 of FIG. 2). For example, the score identifier circuitry 615 identifies the importance score (λ[M]) based on Equation 3, as described in more detail in connection with FIG. 1, to determine the relevance of one modality relative to another modality (e.g., relevance of video-based data as compared to audio-based data in deepfake detection applications). Additionally, the score identifier circuitry 615 determines a linear combination of GMM-based Mahalanobis distances with respect to modality-specific density functions and identifies a modality-specific anomaly detection score with respect to a modality set based on the Mahalanobis distances (e.g., based on Equations 4 and 5). For example, a Mahalanobis distance identifies how far a point is from a center of a multivariate Gaussian distribution (e.g., a measure of the number of standard deviations a point is from the mean of a distribution). However, any other type of distance-based measurement can be implemented. In addition to the modality-specific anomaly detection score, the score identifier circuitry 615 also determines a system-level anomaly detection score (e.g., decomposable anomaly detection score 135 of FIG. 1) based on a summation over all joint distributions (e.g., based on Equation 6).

In some examples, the apparatus includes means for determining an anomaly detection score. For example, the means for determining an anomaly detection score may be implemented by score identifier circuitry 615. In some examples, the score identifier circuitry 615 may be instantiated by programmable circuitry such as the example programmable circuitry 1012 of FIG. 10. For instance, the score identifier circuitry 615 may be instantiated by the example microprocessor 1100 of FIG. 11 executing machine executable instructions such as those implemented by at least block(s) 820, 825, 830, 835 of FIG. 8. In some examples, the score identifier circuitry 615 may be instantiated by hardware logic circuitry, which may be implemented by an ASIC, XPU, or the FPGA circuitry 1200 of FIG. 12 structured to perform operations corresponding to the machine readable instructions. Additionally or alternatively, the score identifier circuitry 615 may be instantiated by any other combination of hardware, software, and/or firmware. For example, the score identifier circuitry 615 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The trainer circuitry 620 trains a multi-modal fusion model (e.g., multi-modal fusion model 300 of FIG. 3) based on the identified modality-specific and system-level anomaly detection scores and/or performs anomaly detection using the trained multi-modal fusion model. As described in connection with FIG. 3, the trainer circuitry 620 trains a model with parallel and independent model streams that process each modality separately, yielding modality-specific predictions before fusing the input features (e.g., via fusion layer 335 of FIG. 3) to obtain a system-based anomaly detection prediction. In some examples, the trainer circuitry 620 trains the multi-modal fusion model using a cross-entropy based, multi-objective loss function and/or implements the trained model to obtain an anomaly detection prediction.

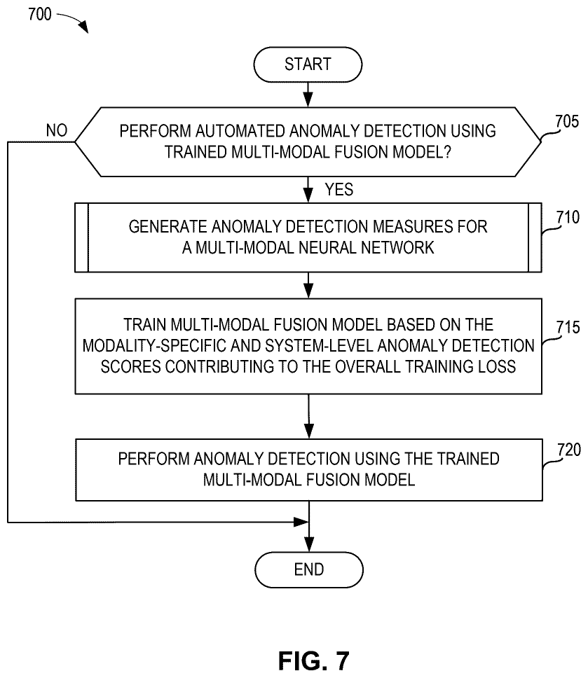

In some examples, the apparatus includes means for training a multi-modal fusion model. For example, the means for training a multi-modal fusion model may be implemented by trainer circuitry 620. In some examples, the trainer circuitry 620 may be instantiated by programmable circuitry such as the example programmable circuitry 1012 of FIG. 10. For instance, the trainer circuitry 620 may be instantiated by the example microprocessor 1100 of FIG. 11 executing machine executable instructions such as those implemented by at least block(s) 715 of FIG. 7. In some examples, the trainer circuitry 620 may be instantiated by hardware logic circuitry, which may be implemented by an ASIC, XPU, or the FPGA circuitry 1200 of FIG. 12 structured to perform operations corresponding to the machine readable instructions. Additionally or alternatively, the trainer circuitry 620 may be instantiated by any other combination of hardware, software, and/or firmware. For example, the trainer circuitry 620 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The data storage 630 can be used to store any information associated with the input identifier circuitry 605, the model fitter circuitry 610, the score identifier circuitry 615 and/or the trainer circuitry 620. The data storage 630 of the illustrated example of FIG. 6 can be implemented by any memory, storage device and/or storage disc for storing data such as flash memory, magnetic media, optical media, etc. Furthermore, the data stored in the data storage 630 can be in any data format such as binary data, comma delimited data, tab delimited data, structured query language (SQL) structures, image data, etc.

While an example manner of implementing the anomaly detector circuitry 105 is illustrated in FIG. 6, one or more of the elements, processes and/or devices illustrated in FIG. 6 may be combined, divided, re-arranged, omitted, eliminated and/or implemented in any other way. Further, the example input identifier circuitry 605, example model fitter circuitry 610, example score identifier circuitry 615, example trainer circuitry 620 and/or, more generally, the example anomaly detector circuitry 105 of FIG. 1 may be implemented by hardware, software, firmware and/or any combination of hardware, software and/or firmware. Thus, for example, the input identifier circuitry 605, the model fitter circuitry 610, the score identifier circuitry 615, the trainer circuitry 620 and/or, more generally, the anomaly detector circuitry 105 of FIG. 1 could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s), ASIC(s)), programmable logic device(s) (PLD(s)), vision processing units (VPUs), and/or field programmable logic device(s) (FPLD(s)) such as FPGAs in combination with machine readable instructions (e.g., firmware or software). Further still, the anomaly detector circuitry 105 of FIG. 1 may include one or more elements, processes, and/or devices in addition to, or instead of, those illustrated in FIG. 6, and/or may include more than one of any or all of the illustrated elements, processes and devices.

Flowcharts representative of example machine readable instructions, which may be executed by programmable circuitry to implement and/or instantiate the anomaly detector circuitry 105 of FIG. 1 and/or representative of example operations which may be performed by programmable circuitry to implement and/or instantiate the anomaly detector circuitry 105 of FIG. 1, are shown in FIGS. 7-9. The machine readable instructions may be one or more executable programs or portion(s) of one or more executable programs for execution by programmable circuitry, such as the programmable circuitry 1012 shown in the example processor platform 1000 discussed below in connection with FIG. 10 and/or may be one or more function(s) or portion(s) of functions to be performed by the example programmable circuitry (e.g., an FPGA) discussed below in connection with FIGS. 11 and/or 12. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 7-9, many other methods of implementing the anomaly detector circuitry 105 of FIG. 1 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 7-9 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 7 is a flowchart representative of example machine-readable instructions and/or example operations 700 that may be executed, instantiated, and/or performed by example programmable circuitry to implement the anomaly detector circuitry 105 of FIG. 1. The machine-readable instructions and/or the operations 700 of FIG. 7 begin at block 705, at which the input identifier circuitry 605 determines whether to perform automated anomaly detection using a multi-modal neural network. For example, the anomaly detector circuitry 105 proceeds to generate anomaly detection measures for a multi-modal neural network, at block 710, when the input identifier circuitry 605 identifies multi-modal data input(s), as described in more detail in connection with FIGS. 8 and 9. For example, the model fitter circuitry 610 fits Gaussian Mixture Models (GMMs) for modality-specific latent embeddings and across combinations of modalities, whereas the score identifier circuitry 615 identifies a modality-specific anomaly detection score and a system-level anomaly detection score based on the GMM fittings using latent embeddings. The trainer circuitry 620 proceeds to train the multi-modal fusion model based on the modality-specific and system-level anomaly detection scores as part of the overall training loss, at block 715. For example, as described in more detail in connection with FIG. 3, the multi-modal fusion model can include a fusion architecture that utilizes parallel and independent model streams that process each modality (e.g., image, video, audio, etc.) separately to yield modality-specific predictions. Once the training is completed, the trainer circuitry 620 initiates anomaly detection using the trained multi-modal fusion model, at block 720. In some examples, the anomaly detection can include assessment of anomalies associated with manufacturing processes or identification of manipulated or fabricated media (e.g., deepfake detection).

FIG. 8 is a flowchart representative of example machine-readable instructions and/or example operations 710 that may be executed, instantiated, and/or performed by the example anomaly detector circuitry 105 of FIG. 1 to generate anomaly detection measures for a multi-modal neural network. The machine-readable instructions and/or the operations 710 of FIG. 8 begin at block 805, at which the model fitter circuitry 610 performs fitting of GMMs for modality-specific latent embeddings of a late-fusion-based multi-modal classifier, at block 805. For example, as described in connection with FIG. 9, the model fitter circuitry 610 performs a GMM fitting to a set of latent embeddings extracted based on the input data modalities. The model fitter circuitry 610 proceeds to fit a set of GMMs across all combinations of modalities using latent model embeddings to yield joint distributions, at block 810. For example, as shown in connection with FIG. 1, the model fitter circuitry 610 generates a joint distribution 131 based on the GMM fitting across the combination of modalities. As described in connection with FIG. 2, the score identifier circuitry 615 performs pooling and normalizing of input feature gradients to estimate an importance score for each modality set over all modality combinations, at block 820. For example, the score identifier circuitry 615 generates a modality importance score 225 of FIG. 2 to determine whether one type of modality (e.g., image) is more relevant over another type of modality (e.g., audio) for a given application (e.g., deepfake detection). In some examples, the score identifier circuitry 615 generates an importance score for sub-modalities of a given modality (e.g., specific facial features as sub-modalities of an input image). Prior to identifying modality-specific and system-level anomaly detection scores, the score identifier circuitry 615 determines a linear combination of GMM-based Mahalanobis distances with respect to modality-specific density functions, at block 825. The score identifier circuitry 615 identifies the modality-specific anomaly detection score with respect to a modality set based on the Mahalanobis distances, at block 830. Subsequently, the score identifier circuitry 615 determines a system-level anomaly detection score based on a summation over all joint distributions, at block 835. For example, as described in more detail in connection with FIG. 1, the score identifier circuitry 615 defines the modality-specific anomaly detection score based on an identification of Mahalanobis distances between an input datum and each joint probability distribution.

FIG. 9 is a flowchart representative of example machine-readable instructions and/or example operations 805 that may be executed, instantiated, and/or performed by the example anomaly detector circuitry 105 of FIG. 1 to perform fitting of Gaussian Mixture Models (GMMs) for modality-specific latent embeddings of a multi-modal classifier. The machine-readable instructions and/or the operations 805 of FIG. 9 begin at block 905, at which the input identifier circuitry 605 identifies input data modalities(S) (e.g., image, text, audio, etc.). The input identifier circuitry 605 also identifies a multi-modal classifier trained on a dataset (D) with respect to the modalities(S), at block 910. The input identifier circuitry 605 uses the trained classifier to extract a set of latent embeddings based on the input modalities, at block 915. As described in connection with FIG. 1, the latent embeddings represent compressed representations of input data that are derived from the penultimate layer of the neural network. The model fitter circuitry 610 performs a GMM fitting to the extracted set of latent embeddings, at block 920, which is further used to determine a modality-specific and system-level anomaly detection score, as described in connection with FIG. 8.

FIG. 10 is a block diagram of an example processing platform 1000 including programmable circuitry structured to execute, instantiate, and/or perform the example machine readable instructions and/or perform the example operations of FIGS. 7-9 to implement the example anomaly detector circuitry 105 of FIG. 1. The programmable circuitry platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1000 of the illustrated example includes programmable circuitry 1012. The programmable circuitry 1012 of the illustrated example is hardware. For example, the programmable circuitry 1012 can be implemented by one or more integrated circuits, logic circuits, FPGAs microprocessors, CPUs, GPUs, DSPs, and/or microcontrollers from any desired family or manufacturer. The programmable circuitry 1012 may be implemented by one or more semiconductor based (e.g., silicon based) devices. In this example, the processor circuitry 1012 implements input identifier circuitry 605, model fitter circuitry 610, score identifier circuitry 615, and trainer circuitry 620.

The programmable circuitry 1012 of the illustrated example includes a local memory 1013 (e.g., a cache, registers, etc.). The programmable circuitry 1012 of the illustrated example is in communication with a main memory including a volatile memory 1014 and a non-volatile memory 1016 by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017. In some examples, the memory controller 1017 may be implemented by one or more integrated circuits, logic circuits, microcontrollers from any desired family or manufacturer, or any other type of circuitry to manage the flow of data going to and from the main memory 1014, 1016.

The programmable circuitry platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1022 are connected to the interface circuitry 1020. The input device(s) 1022 permit(s) a user (e.g., a human user, a machine user, etc.) to enter data and/or commands into the programmable circuitry 1012. The input device(s) 1022 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1024 are also connected to the interface circuitry 1020 of the illustrated example. The output devices 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The programmable circuitry platform 1000 of the illustrated example also includes one or more mass storage devices 1028 to store software and/or data. Examples of such mass storage devices 1028 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine executable instructions 1032, which may be implemented by the machine readable instructions of FIGS. 7-9, may be stored in the mass storage device 1028, in the volatile memory 1014, in the non-volatile memory 1016, and/or on at least one non-transitory computer readable storage medium such as a CD or DVD which may be removable.

FIG. 11 is a block diagram of an example implementation of the programmable circuitry 1012 of FIG. 10. In this example, the programmable circuitry 1012 of FIG. 10 is implemented by a microprocessor 1100. For example, the microprocessor 1100 may be a general purpose microprocessor (e.g., general purpose microprocessor circuitry). The microprocessor 1100 executes some or all of the machine readable instructions of the flowcharts of FIGS. 7-9 to effectively instantiate the circuitry of FIG. 6 logic circuits to perform the operations corresponding to those machine readable instructions. In some such examples, the circuitry of FIG. 6 is instantiated by the hardware circuits of the microprocessor 1100 in combination with the instructions. For example, the microprocessor 1100 may implement multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all of the machine readable instructions and/or operations represented by the flowcharts of FIGS. 7-9.

The cores 1102 may communicate by a first example bus 1104. In some examples, the first bus 1104 may implement a communication bus to effectuate communication associated with one(s) of the cores 1102. For example, the first bus 1104 may implement at least one of an Inter-Integrated Circuit (I2C) bus, a Serial Peripheral Interface (SPI) bus, a PCI bus, or a PCIe bus. Additionally or alternatively, the first bus 1104 may implement any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2_cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 10). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the L1 cache 1120, and a second example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer-based operations. In other examples, the AL circuitry 1116 also performs floating-point operations. In yet other examples, the AL circuitry 1116 may include first AL circuitry that performs integer-based operations and second AL circuitry that performs floating point operations. In some examples, the AL circuitry 1116 may be referred to as an Arithmetic Logic Unit (ALU).

The registers 1118 are semiconductor-based structures to store data and/or instructions such as results of one or more of the operations performed by the AL circuitry 1116 of the corresponding core 1102. For example, the registers 1118 may include vector register(s), SIMD register(s), general purpose register(s), flag register(s), segment register(s), machine specific register(s), instruction pointer register(s), control register(s), debug register(s), memory management register(s), machine check register(s), etc. The registers 1118 may be arranged in a bank as shown in FIG. 11. Alternatively, the registers 1118 may be organized in any other arrangement, format, or structure including distributed throughout the core 1102 to shorten access time. The second bus 1122 may be implemented by at least one of an I2C bus, a SPI bus, a PCI bus, or a PCIe bus.

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages.

The microprocessor 1100 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1100, in the same chip package as the microprocessor 1100 and/or in one or more separate packages from the microprocessor 1100.

FIG. 12 is a block diagram of another example implementation of the programmable circuitry of FIG. 10. In this example, the programmable circuitry 1012 is implemented by FPGA circuitry 1200. For example, the FPGA circuitry 1200 may be implemented by an FPGA. The FPGA circuitry 1200 can be used, for example, to perform operations that could otherwise be performed by the example microprocessor 1200 of FIG. 12 executing corresponding machine readable instructions. However, once configured, the FPGA circuitry 1200 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1100 of FIG. 11 described above (which is a general purpose device that may be programmed to execute some or all of the machine readable instructions represented by the flowcharts of FIGS. 7-9 but whose interconnections and logic circuitry are fixed once fabricated), the FPGA circuitry 1200 of the example of FIG. 12 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 7-9. In particular, the FPGA 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 7-9. As such, the FPGA circuitry 1200 may be configured and/or structured to effectively instantiate some or all of the operations/functions corresponding to the machine readable instructions of the flowcharts of FIGS. 7-9 as dedicated logic circuits to perform the operations/functions corresponding to those software instructions in a dedicated manner analogous to an ASIC. Therefore, the FPGA circuitry 1200 may perform the operations/functions corresponding to the some or all of the machine readable instructions of FIGS. 7-9 faster than the general-purpose microprocessor can execute the same.

In the example of FIG. 12, the FPGA circuitry 1200 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

The FPGA circuitry 1200 of FIG. 12, includes example input/output (I/O) circuitry 1202 to obtain and/or output data to/from example configuration circuitry 1204 and/or external hardware 1206. For example, the configuration circuitry 1204 may be implemented by interface circuitry that may obtain a binary file, which may be implemented by a bit stream, data, and/or machine-readable instructions, to configure the FPGA circuitry 1200, or portion(s) thereof. In some such examples, the configuration circuitry 1204 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1206 may be implemented by external hardware circuitry. For example, the external hardware 1206 may be implemented by the microprocessor 1100 of FIG. 11.

The FPGA circuitry 1200 also includes an array of example logic gate circuitry 1208, a plurality of example configurable interconnections 1210, and example storage circuitry 1212. The logic gate circuitry 1208 and the configurable interconnections 1210 are configurable to instantiate one or more operations/functions that may correspond to at least some of the machine readable instructions of FIGS. 7-9 and/or other desired operations. The logic gate circuitry 1208 shown in FIG. 12 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations/functions. The logic gate circuitry 1208 may include other electrical structures such as look-up tables (LUTs), registers (e.g., flip-flops or latches), multiplexers, etc.

The configurable interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 12 also includes example dedicated operations circuitry 1214. In this example, the dedicated operations circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 11 and 12 illustrate two example implementations of the programmable circuitry 1012 of FIG. 10, many other approaches are contemplated. For example, FPGA circuitry may include an on-board CPU, such as one or more of the example CPU 1220 of FIG. 12. Therefore, the programmable circuitry 1012 of FIG. 10 may additionally be implemented by combining at least the example microprocessor 1100 of FIG. 11 and the example FPGA circuitry 1200 of FIG. 12. In some such hybrid examples, one or more cores 1202 of FIG. 12 may execute a first portion of the machine readable instructions represented by the flowchart(s) of FIGS. 7-9 to perform first operation(s)/function(s), the FPGA circuitry 1200 of FIG. 12 may be configured and/or structured to perform second operation(s)/function(s) corresponding to a second portion of the machine readable instructions represented by the flowcharts of FIGS. 7-9, and/or an ASIC may be configured and/or structured to perform third operation(s)/function(s) corresponding to a third portion of the machine readable instructions represented by the flowcharts of FIGS. 7-9.

It should be understood that some or all of the circuitry of FIG. 6 may, thus, be instantiated at the same or different times. For example, same and/or different portion(s) of the microprocessor 1100 of FIG. 11 may be programmed to execute portion(s) of machine-readable instructions at the same and/or different times. In some examples, same and/or different portion(s) of the FPGA circuitry 1200 of FIG. 12 may be configured and/or structured to perform operations/functions corresponding to portion(s) of machine-readable instructions at the same and/or different times.

In some examples, some or all of the circuitry of FIG. 6 may be instantiated, for example, in one or more threads executing concurrently and/or in series. For example, the microprocessor 1100 of FIG. 11 may execute machine readable instructions in one or more threads executing concurrently and/or in series. In some examples, the FPGA circuitry 1200 of FIG. 12 may be configured and/or structured to carry out operations/functions concurrently and/or in series. Moreover, in some examples, some or all of the circuitry of FIG. 6 may be implemented within one or more virtual machines and/or containers executing on the microprocessor 1100 of FIG. 11.

In some examples, the programmable circuitry 1012 of FIG. 10 may be in one or more packages. For example, the microprocessor 1100 of FIG. 11 and/or the FPGA circuitry 1200 of FIG. 12 may be in one or more packages. In some examples, an XPU may be implemented by the programmable circuitry 1012 of FIG. 10 which may be in one or more packages. For example, the XPU may include a CPU (e.g., the microprocessor 1100 of FIG. 11, the CPU 1220 of FIG. 12, etc.) in one package, a DSP (e.g., the DSP 1222 of FIG. 12) in another package, a GPU in yet another package, and an FPGA (e.g., the FPGA circuitry 1200 of FIG. 12) in still yet another package.

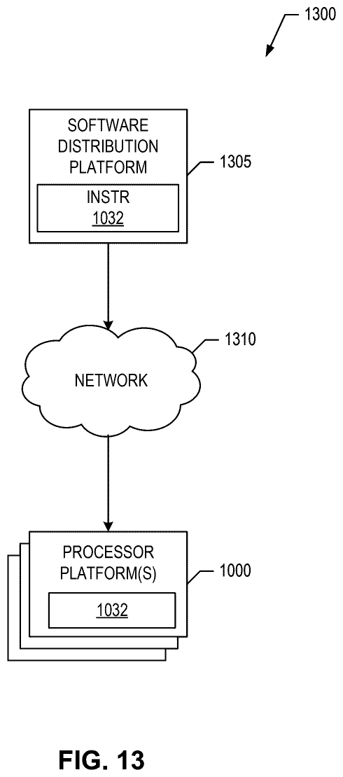

A block diagram illustrating an example software distribution platform 1305 to distribute software such as the example machine readable instructions 1032 of FIG. 10 to other hardware devices (e.g., hardware devices owned and/or operated by third parties from the owner and/or operator of the software distribution platform) is illustrated in FIG. 13. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine readable instructions 1032 of FIG. 10. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 1032, which may correspond to the example machine readable instructions of FIGS. 7-9, as described above. The one or more servers of the example software distribution platform 1305 are in communication with an example network 1310, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1032 from the software distribution platform 1305. For example, the software, which may correspond to the example machine readable instructions of FIGS. 7-9, may be downloaded to the example programmable circuitry platform 1000, which is to execute the machine readable instructions 1032 to implement the anomaly detector circuitry 105 of FIG. 1. In some examples, one or more servers of the software distribution platform 1305 periodically offer, transmit, and/or force updates to the software (e.g., the example machine readable instructions 1032 of FIG. 10) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, methods, apparatus, and articles of manufacture disclosed herein introduce decomposable probabilistic multi-modal anomaly detection. In examples disclosed herein, Decomposable Probabilistic Multi-Modal Anomaly Detection (DP-MMAD) improves the robustness of anomaly detection (AD) while enhancing system explainability and trustworthiness. For example, DP-MMAD yields a system-level AD score in addition to modality-specific AD scores for all modalities present in the system. Methods and apparatus disclosed herein determine AD measures for multi-modal neural network systems based on a fitting of Gaussian Mixture Models (GMMs) for modality-specific latent embeddings of a multi-modal classifier and a fitting of an additional set of joint GMMs over all modality combinations. For example, an importance score for a modality or modalities of interest can be identified by pooling and normalizing input feature gradients, since anomaly detection in multi-modal systems is impacted by the contribution of a given modality. Methods and apparatus disclosed herein introduce consistent and accurate automated AD that can be implemented for improving cost and efficiency across a diverse array of other application domains, including deepfake detection. Thus, examples disclosed herein result in improvements to the operation of a machine.

Example methods, apparatus, systems, and articles of manufacture for decomposable probabilistic multi-modal anomaly detection are disclosed herein. Further examples and combinations thereof include the following:
Example 1 includes an apparatus, comprising interface circuitry, machine-readable instructions, and at least one processor circuit to be programmed by the machine-readable instructions to generate a probability distribution based on latent embeddings extracted from a dataset, the probability distribution representing interactions between a plurality of data modalities in the dataset, and determine an anomaly detection score based on the probability distribution and an importance score, the anomaly detection score corresponding to at least one of (1) an anomaly of a single data modality or (2) an anomaly of two or more data modalities.
Example 2 includes the apparatus as defined in example 1, wherein one or more of the at least one processor circuit is to estimate the importance score based on pooling and normalization of input feature gradients of the single data modality.
Example 3 includes the apparatus as defined in one or more of examples 1-2, wherein one or more of the at least one processor circuit is to adjust a predictive analytical workflow based on the anomaly detection score.
Example 4 includes the apparatus as defined in one or more of examples 1-3, wherein one or more of the at least one processor circuit is to perform deepfake detection based on the anomaly detection score.
Example 5 includes the apparatus as defined in one or more of examples 1-4, wherein the data modalities include at least one of a text, an image, an audio, or a video.
Example 6 includes the apparatus as defined in one or more of examples 1-5, wherein the probability distribution is generated based on a Gaussian Mixture Model (GMM), one or more of the at least one processor circuit is to identify the anomaly detection score based on a linear combination of GMM-based Mahalanobis distances.
Example 7 includes the apparatus as defined in one or more of examples 1-6, wherein one or more of the at least one processor circuit is to identify the anomaly detection score based on a summation over joint distributions, the joint distributions generated during GMM-based fitting across combinations of the data modalities.
Example 8 includes the apparatus as defined in one or more of examples 1-7, wherein the latent embeddings are penultimate layer activations extracted by passing the dataset through a trained classifier of a multi-modal neural network.
Example 9 includes at least one non-transitory machine-readable medium comprising machine-readable instructions to cause at least one processor circuit to at least generate a probability distribution based on latent embeddings extracted from a dataset, the probability distribution representing interactions between a plurality of data modalities in the dataset, and determine an anomaly detection score based on the probability distribution and an importance score, the anomaly detection score corresponding to at least one of (1) an anomaly of a single data modality or (2) an anomaly of two or more data modalities.
Example 10 includes the at least one non-transitory machine-readable medium as defined in example 9, wherein the machine-readable instructions are to cause one or more of the at least one processor circuit to estimate the importance score based on pooling and normalization of input feature gradients of the single data modality.
Example 11 includes the at least one non-transitory machine-readable medium as defined in one or more of examples 9-10, wherein the machine-readable instructions are to cause one or more of the at least one processor circuit to adjust a predictive analytical workflow based on the anomaly detection score.
Example 12 includes the at least one non-transitory machine-readable medium as defined in one or more of examples 9-11, wherein the machine-readable instructions are to cause one or more of the at least one processor circuit to perform deepfake detection based on the anomaly detection score.
Example 13 includes the at least one non-transitory machine-readable medium as defined in one or more of examples 9-12, wherein the data modalities include at least one of a text, an image, an audio, or a video.
Example 14 includes the at least one non-transitory machine-readable medium as defined in one or more of examples 9-13, wherein the probability distribution is generated based on a Gaussian Mixture Model (GMM), the machine-readable instructions are to cause one or more of the at least one processor circuit to identify the anomaly detection score based on a linear combination of GMM-based Mahalanobis distances.
Example 15 includes the at least one non-transitory machine-readable medium as defined in one or more of examples 9-14, wherein the machine-readable instructions are to cause one or more of the at least one processor circuit to identify the anomaly detection score based on a summation over joint distributions, the joint distributions generated during GMM-based fitting across combinations of the data modalities.
Example 16 includes the at least one non-transitory machine-readable medium as defined in one or more of examples 9-15, wherein the latent embeddings are penultimate layer activations extracted by passing the dataset through a trained classifier of a multi-modal neural network.
Example 17 includes an apparatus, comprising means for generating a probability distribution based on latent embeddings extracted from a dataset, the probability distribution representing interactions between a plurality of data modalities in the dataset, and means for determining an anomaly detection score based on the probability distribution and an importance score, the anomaly detection score corresponding to at least one of (1) an anomaly of a single data modality or (2) an anomaly of two or more data modalities.
Example 18 includes the apparatus as defined in example 17, wherein the means for determining is to estimate the importance score based on pooling and normalization of input feature gradients of the single data modality.
Example 19 includes the apparatus as defined in one or more of examples 17-18, wherein the data modalities include at least one of a text, an image, an audio, or a video.
Example 20 includes the apparatus as defined in one or more of examples 17-19, wherein the latent embeddings are penultimate layer activations extracted by passing the dataset through a classifier of a multi-modal neural network.
Example 21 includes the apparatus as defined in one or more of examples 17-20, further including means for training to adjust a predictive analytical workflow based on the anomaly detection score.
Example 22 includes the apparatus as defined in one or more of examples 17-21, further including means for training to perform deepfake detection based on the anomaly detection score.
Example 23 includes the apparatus as defined in one or more of examples 17-22, wherein the probability distribution is generated based on a Gaussian Mixture Model (GMM), the means for determining is to identify the anomaly detection score based on a linear combination of GMM-based Mahalanobis distances.
Example 24 includes the apparatus as defined in one or more of examples 17-23, wherein the means for determining the anomaly detection score is to identify the anomaly detection score based on a summation over joint distributions, the joint distributions generated during GMM-based fitting across combinations of the data modalities.
Example 25 includes a method, comprising generating a probability distribution based on latent embeddings extracted from a dataset, the probability distribution representing interactions between a plurality of data modalities in the dataset, and determining an anomaly detection score based on the probability distribution and an importance score, the anomaly detection score corresponding to at least one of (1) an anomaly of a single data modality or (2) an anomaly of two or more data modalities.
Example 26 includes the method as defined in example 25, further including estimating the importance score based on pooling and normalization of input feature gradients of the single data modality.
Example 27 includes the method as defined in one or more of examples 25-26, further including adjusting a predictive analytical workflow based on the anomaly detection score.
Example 28 includes the method as defined in one or more of examples 25-27, further including performing deepfake detection based on the anomaly detection score.
Example 29 includes the method as defined in one or more of examples 25-28, wherein the data modalities include at least one of a text, an image, an audio, or a video.
Example 30 includes the method as defined in one or more of examples 25-29, wherein the probability distribution is generated based on a Gaussian Mixture Model (GMM), further including identifying the anomaly detection score based on a linear combination of GMM-based Mahalanobis distances.
Example 31 includes the method as defined in one or more of examples 25-30, further including identifying the anomaly detection score based on a summation over joint distributions, the joint distributions generated during GMM-based fitting across combinations of the data modalities.
Example 32 includes the method as defined in one or more of examples 25-31, wherein the latent embeddings are penultimate layer activations extracted by passing the dataset through a trained classifier of a multi-modal neural network.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus, comprising:
interface circuitry;
machine-readable instructions; and
at least one processor circuit to be programmed by the machine-readable instructions to:
generate a probability distribution based on latent embeddings extracted from a dataset, the probability distribution representing interactions between a plurality of data modalities in the dataset; and
determine an anomaly detection score based on the probability distribution and an importance score, the anomaly detection score corresponding to at least one of (1) an anomaly of a single data modality or (2) an anomaly of two or more data modalities.

2. The apparatus of claim 1, wherein one or more of the at least one processor circuit is to estimate the importance score based on pooling and normalization of input feature gradients of the single data modality.

3. The apparatus of claim 1, wherein one or more of the at least one processor circuit is to adjust a predictive analytical workflow based on the anomaly detection score.

4. The apparatus of claim 1, wherein one or more of the at least one processor circuit is to perform deepfake detection based on the anomaly detection score.

5. The apparatus of claim 1, wherein the data modalities include at least one of a text, an image, an audio, or a video.

6. The apparatus of claim 1, wherein the probability distribution is generated based on a Gaussian Mixture Model (GMM), one or more of the at least one processor circuit is to identify the anomaly detection score based on a linear combination of GMM-based Mahalanobis distances.

7. The apparatus of claim 6, wherein one or more of the at least one processor circuit is to identify the anomaly detection score based on a summation over joint distributions, the joint distributions generated during GMM-based fitting across combinations of the data modalities.

8. The apparatus of claim 1, wherein the latent embeddings are penultimate layer activations extracted by passing the dataset through a trained classifier of a multi-modal neural network.

9. At least one non-transitory machine-readable medium comprising machine-readable instructions to cause at least one processor circuit to at least:
generate a probability distribution based on latent embeddings extracted from a dataset, the probability distribution representing interactions between a plurality of data modalities in the dataset; and
determine an anomaly detection score based on the probability distribution and an importance score, the anomaly detection score corresponding to at least one of (1) an anomaly of a single data modality or (2) an anomaly of two or more data modalities.

10. The at least one non-transitory machine-readable medium of claim 9, wherein the machine-readable instructions are to cause one or more of the at least one processor circuit to estimate the importance score based on pooling and normalization of input feature gradients of the single data modality.

11. The at least one non-transitory machine-readable medium of claim 9, wherein the machine-readable instructions are to cause one or more of the at least one processor circuit to adjust a predictive analytical workflow based on the anomaly detection score.

12. The at least one non-transitory machine-readable medium of claim 9, wherein the machine-readable instructions are to cause one or more of the at least one processor circuit to perform deepfake detection based on the anomaly detection score.

13. The at least one non-transitory machine-readable medium of claim 9, wherein the data modalities include at least one of a text, an image, an audio, or a video.

14. The at least one non-transitory machine-readable medium of claim 9, wherein the probability distribution is generated based on a Gaussian Mixture Model (GMM), the machine-readable instructions are to cause one or more of the at least one processor circuit to identify the anomaly detection score based on a linear combination of GMM-based Mahalanobis distances.

15. The at least one non-transitory machine-readable medium of claim 14, wherein the machine-readable instructions are to cause one or more of the at least one processor circuit to identify the anomaly detection score based on a summation over joint distributions, the joint distributions generated during GMM-based fitting across combinations of the data modalities.

16. The at least one non-transitory machine-readable medium of claim 9, wherein the latent embeddings are penultimate layer activations extracted by passing the dataset through a trained classifier of a multi-modal neural network.

17. An apparatus, comprising:
means for generating a probability distribution based on latent embeddings extracted from a dataset, the probability distribution representing interactions between a plurality of data modalities in the dataset; and
means for determining an anomaly detection score based on the probability distribution and an importance score, the anomaly detection score corresponding to at least one of (1) an anomaly of a single data modality or (2) an anomaly of two or more data modalities.

18. The apparatus of claim 17, wherein the means for determining is to estimate the importance score based on pooling and normalization of input feature gradients of the single data modality.

19. The apparatus of claim 17, wherein the data modalities include at least one of a text, an image, an audio, or a video.

20. The apparatus of claim 17, wherein the latent embeddings are penultimate layer activations extracted by passing the dataset through a classifier of a multi-modal neural network.
